(19) United States
(12) Patent Application Publication
(10) Pub. No.: US 2002/0106472 A1
(43) Pub. Date: Aug. 8, 2002

(54) Structure of a light-flashing adhesive paper

(76) Inventor: Chien-Lung Liao, Taipei (TW)

Correspondence Address: LIAO, Chien-Lung, PO Box 82-144, Taipei, TW

(21) Appl. No.: 09/777,841

(22) Filed: Feb. 7, 2001

(51) Int. Cl. B32B 9/00

(52) U.S. Cl. 428/42.1; 428/41.8

(57) ABSTRACT

The present invention relates a structure of a light-flashing adhesive paper comprising an adhesive layer, a body structure, a light-flashing core-element and an adhesive paper, wherein the adhesive paper is glued at the front face of the body structure, and the adhesive layer has double-sided adhesive surfaces having one surface adhered to the back of the body structure as one unit and the other surface being protected by the adhesive paper. The light-flashing adhesive paper can be functioned as flashing articles, Christmas decorative articles, light-flashing identification articles, etc.

### BACKGROUND OF THE INVENTION

(a) Field of the Invention

The present invention relates to light-flashing adhesive paper, and in particular to the body structure of adhesive paper producing a flashing effect to provide fun for children.

(b) Description of the Prior Art

Conventional adhesive paper provided fun for children has lost its novelty to attract children for the reason that the structure of the adhesive layer has not been changed for such a long time. In other words, the conventional adhesive paper does not improve the structure thereof in order to provide flashing effect to attract the children. In addition, the media for the adhesion of the adhesive paper affects the duration of storage of the adhesive paper, and the conventional adhesive paper will loss its flashing effect and adhesion function after a long period of storage.

Accordingly it is a main object of the present invention to overcome the above drawback by providing an improved structure of a light-flashing adhesive paper.

### SUMMARY OF THE INVENTION

Accordingly, it is an object of the present invention to provide a structure of a light-flashing adhesive paper comprising an adhesive layer, a body structure, a light-flashing core-element and an adhesive paper, wherein the adhesive paper is glued at the front face of the body structure, and the adhesive layer has double-sided adhesive surfaces having one surface adhered to the back of the body structure as one unit and the other surface being protected by the adhesive paper, characterized in that the body structure is constituted by two combination plates, one of the plate having one inner face to mount the light-flashing core-element at a core-element position slot provided thereto, the light-flashing core-element being located in between the two combination plates, the top edge of the combination plates is provided with a connection section and the inner edge surface of the connection section has a cutting face such that after the combination of the combination plates, an appropriate width is obtained; the bottom edge of two combination plates is an opened configuration and the inner bottom edge of one of the combination plates is provided with a peg head for mounting with the peg slot at the other combination plates so as to provide quick mounting of the peg positioning; the light-flashing core-element has a ultra-thin battery to provide power source to drive a light-emitting element to flash and a switch button is located within a hole located at the core-element positioning slot; thereby, the pressing at the center section of the combination plates, the power source is triggered to drive the light-emitting element to flash.

Other objections and advantages of the present inventions are as follows:

(1) The light-flashing adhesive paper of the present invention possesses novelty to provide fun for children.

(2) The light-flashing core-element of the body structure or the body structure per se can be easily and rapidly replaced.

(3) The light-flashing adhesive paper can be used as flashing articles, Christmas decorative article, light-flashing identification article, etc. so as to provide light-flashing effects.

(4) The light-flashing body structure provides adhesion for other types of adhesive paper such as flat or planar adhesive paper, high refractive adhesive paper, or 3D crystaine adhesive paper, etc.

### BRIEF DESCRIPTION OF THE DRAWINGS

FIG. 1 is a perspective view of a preferred embodiment of the present invention.

FIG. 2 is a perspective exploded view of the present invention.

FIG. 3 is a sectional view of the adhesive paper in accordance with the present invention.

FIG. 4 is a sectional view of the entire structure of the present invention.

FIG. 5 is a side view of the suspension decorative article in accordance with the present invention.

### DETAILED DESCRIPTION OF THE PRESENT INVENTION

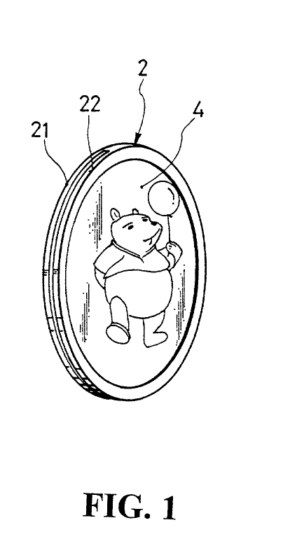

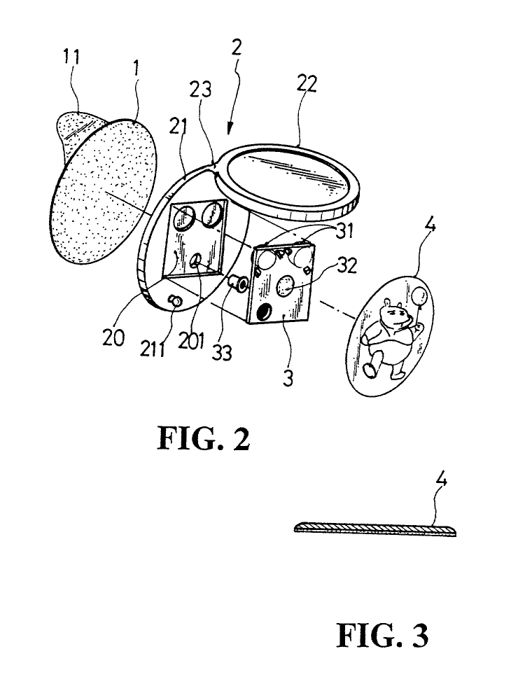

Referring to FIGS. 1 and 2, there is shown a structure of a light-flashing adhesive paper comprising an adhesive layer 1, a body structure 2, a light-flashing core-element 3 and an adhesive paper 4, wherein the adhesive paper 1 is glued at the front face of the body structure 2, and the adhesive layer 1 has double-sided adhesive surfaces having one surface adhered to the back of the body structure 2 as one unit and the other surface being protected by the adhesive paper 4. When the adhesive paper is released, the entire body structure 2 can be adhered to other surface.

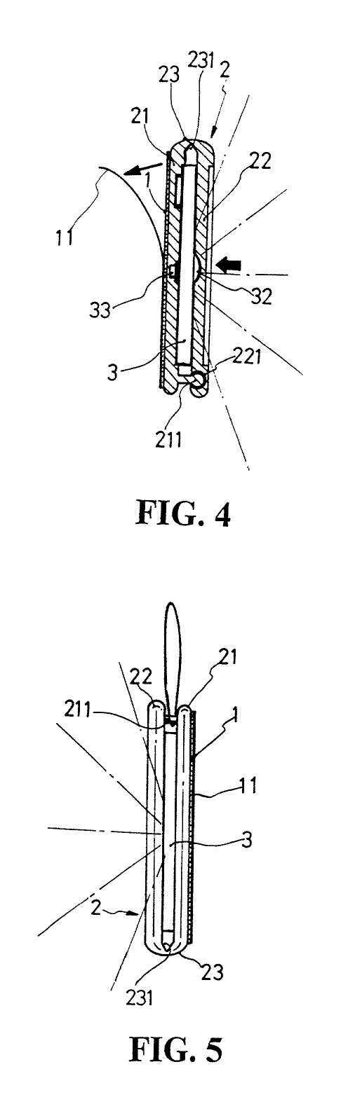

Referring to FIG. 4, the body structure 2 is constituted by two combination plates 21, 22, one of the plate having one inner face to mount the light-flashing core-element 3 at a core-element position slot 20 provided thereto, the light-flashing core-element 3 being located in between the two combination plates 21, 22, the top edge of the combination plates 21, 22 being provided with a connection section 23 and the inner edge surface of the connection section 23 having a cutting face 231 such that after the combination of the combination plates 21, 22, an appropriate width is obtained.

In addition, the bottom edge of two combination plates 21, 22 is an opened configuration and the inner bottom edge of one of the combination plates 21, is provided with a peg head 211 for mounting with the peg slot 221 at the other combination plates 22 so as to provide quick mounting of peg positioning so that the light-flashing core-element 3 will not be easily dislocated.

Referring to FIG. 5, the peg head 211 and the peg slot 221 being inverted to 180 degree can be used as a suspension decorative article, such as flashing plate, Christmas decorative articles, flashing name tags, etc.

Referring to FIG. 2, the light-flashing core-element 3 has a ultra-thin battery 31 to provide power source to drive a light-emitting element 32 to flash and a switch button 33 is located within a hole 201 located at the core-element positioning slot 20, thereby the pressing at the center section of the combination plates 21, 22, the power source is triggered to drive the light-emitting element 32 to flash. The light passes through the body structure and the entire surface of the adhesive paper 4, and the pattern or design of the adhesive paper 4 is shown beautifully in particular, in the night or in darker light condition.

In accordance with the present invention, the adhesive paper 4 is selected from flat adhesive paper, high-refractive adhesive paper, and 3D crystalline adhesive paper. These adhesive papers provide excellent effects.

The body structure 2 is either square or round to match the shape of the adhesive paper, or transparent or colored body with multiple cut angle of high refraction to produce color lights and the light-emitting element 32 of the light-flashing core-element 3 comprises more than one core-elements 3.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A structure of a light-flashing adhesive paper comprising an adhesive layer, a body structure, a light-flashing core-element and an adhesive paper, wherein the adhesive paper is glued at the front face of the body structure, and the adhesive layer has double-sided adhesive surfaces having one surface adhered to the back of the body structure as one unit and the other surface being protected by the adhesive paper, characterized in that
(a) the body structure is constituted by two combination plates, one of the plate having one inner face to mount the light-flashing core-element at a core-element position slot provided thereto, the light-flashing core-element being located in between the two combination plates, the top edge of the combination plates is provided with a connection section and the inner edge surface of the connection section has a cutting face such that after the combination of the combination plates, an appropriate width is obtained;
the bottom edge of two combination plates is an opened configuration and the inner bottom edge of one of the combination plates is provided with a peg head for mounting with the peg slot at the other combination plates so as to provide quick mounting of the peg positioning;
(b) the light-flashing core-element has a ultra-thin battery to provide power source to drive a light-emitting element to flash and a switch button is located within a hole located at the core-element positioning slot;
thereby by means of pressing at the center section of the combination plates, the power source is triggered to drive the light-emitting element to flash.

2. A structure of a light-flashing adhesive paper as set forth in claim 1, wherein the adhesive paper is selected from flat adhesive paper, high-refractive adhesive paper, 3D crystalline adhesive paper.

3. A structure of a light-flashing adhesive paper as set forth in claim 1, wherein the body structure is either square or round to match the shape of the adhesive paper, or transparent or colored body with multiple cut angle of high refraction to produce color lights.

4. A structure of a light-flashing adhesive paper as set forth in claim 1, wherein the light emitting of the light-flashing core-element comprises more than one core-element.
